(19) United States
(12) Patent Application Publication
(10) Pub. No.: US 2010/0148512 A1
(43) Pub. Date: Jun. 17, 2010

(54) Apparatus for generating electricity from flowing fluid using generally prolate turbine

(75) Inventor: John Pitre, Honolulu, HI (US)

Correspondence Address: STEPTOE & JOHNSON LLP, 1330 CONNECTICUT AVENUE, N.W., WASHINGTON, DC, 20036, US

(73) Assignee: Natural Power Concepts, Inc., Honolulu, HI (US)

(21) Appl. No.: 12/461,715

(22) Filed: Aug. 21, 2009

Related U.S. Application Data
(60) Provisional application No. 61/202,126, filed on Jan. 30, 2009.
(60) Provisional application No. 61/189,950, filed on Aug. 22, 2008.

(51) Int. Cl. F03B 13/00

(52) U.S. Cl. 290/54

(57) ABSTRACT

An apparatus for generating electricity from a moving liquid has a generally oblate casing and a generally helicoid working member adapted to convert energy of a flowing fluid into rotation of the casing. A rotor-like element of an electrical generator is coupled to the rotating casing. A stator like element of an electrical generator is coupled to a stabilizing element. The stabilizing element may be a fin, a counter-rotating turbine, or another structure that develops torque from the moving liquid.

### CROSS-REFERENCE TO RELATED APPLICATIONS

This application claims priority to U.S. Provisional Patent Application 61/189,950 entitled, “Fine Arts Innovations,” and filed Aug. 22, 2008, and 61/202,126 entitled “Apparatus for Generating Electricity from Flowing Fluid Using Generally Prolate Turbine,” and filed Jan. 30, 2009, the disclosures of which are incorporated herein by reference in their entireties.

### STATEMENT REGARDING FEDERALLY SPONSORED RESEARCH OR DEVELOPMENT

None.

### NAMES OF THE PARTIES TO A JOINT RESEARCH AGREEMENT

None.

### BACKGROUND

The generation of electricity from water today predominantly uses impoundments, such as dams.

To convert water currents into electricity without impoundments, in-stream energy conversion devices are placed in a flowing stream. According to the Electric Power Research Institute, such in-stream electricity generation without using impoundments remains a largely untapped potential. See, e.g., “North American Ocean Energy Status,” Electric Power Research Institute, March 2007. This report states that the world's first marine renewable energy system of significant size to be installed in a genuinely offshore location was the Marine Current Turbine (MCT) 300 kw experimental SeaFlow unit installed off the coast of Devon, UK in May 2003. The MCT SeaFlow unit used a rotating, axial-flow turbine using hydrodynamic, generally planar blades as working members. (The term “working member” here refers to a member having a surface that functions to react with a working fluid, such as water, such that movement of a working fluid causes movement of the working member.) The report discusses other in-stream projects that use axial-flow turbines with generally planar blades. The Verdant Power 5.5 axial flow turbines were installed in the East River of New York beginning in December 2006. The Canadian Race Rocks British Columbia Tidal Project delivered electricity for the first time in December 2006.

### SUMMARY

An object of some embodiments of the invention is to provide an improved, in-stream apparatus for generating electricity from fluid flows, especially relatively shallow river and tidal flows. Other objects of some embodiments the invention are to provide:
(a) improved apparatus for generating electricity with low impact on marine life,
(b) improved apparatus for generating electricity in reversible current flows, such as tidal flows,
(c) improved apparatus for generating electricity at low cost, and
(d) scalable arrangements of apparatus for generating electricity.

These and other objects are achieved by providing a turbine that uses a generally helicoid working member to convert a tidal or river flow into rotational motion of a generally prolate carrier. (By way of non-limiting example, a football could be considered as having a prolate shape.) Helicoid working members on the exterior of such carriers reject debris, and they tend not to catch or otherwise harm marine life. The generally prolate shape can have low drag, provide an internal volume for electricity-generation equipment, and provide buoyancy through displacement, if desired. The generally prolate shape can accelerate fluid flow around its periphery and provide an increased radial moment and increased torque about its central axis when compared to comparably-sized working members on a circular cylinder. They can work well partially submerged in shallow surface currents as well as completely submerged in deeper water applications.

The turbine generates electricity by causing relative rotation of stator-like and rotor-like elements of an electrical generator. (The terms “stator-like” and “rotor-like” are used here as broader terms than “stator” and “rotor” in that they do not require either to be fixed or rotating, nor do they require either to have a specific internal construction. For example, where an electric generator uses magnets in one element and coils in another element, either or neither may be fixed, and one or both may be rotating when viewed from an external point of reference. Either may be a “stator-like” or “rotor-like” element.) Various arrangements may be used to cause relative motion between a stator-like element of an electrical generator and a rotor-like element. A fin may be provided to hold the stator-like member in a relatively fixed orientation when viewed from an outside reference point. Alternately, the stator-like member may be driven by another turbine to counter-rotate relative to the rotor-like element.

Multiple turbines may be anchored in groups in tidal, river, or other streams. Their axes of rotation preferably will be generally parallel with the prevailing fluid flow, but it has been found that the prolate carrier and helicoid working member also perform well with oblique currents. Their rotational axes may be coaxial (in line) or offset.

### BRIEF DESCRIPTION OF THE SEVERAL VIEWS OF THE DRAWING

Reference will be made to the following drawings, which illustrate preferred embodiments of the invention as contemplated by the inventor(s).

FIG. 1 illustrates a top plan view of a generally prolate turbine according to an embodiment of the invention.

FIG. 2 illustrates a side plan view of a generally prolate turbine according to an embodiment of the invention.

FIG. 3 illustrates a front plan view of a generally prolate turbine according to an embodiment of the invention.

FIG. 4 illustrates a series arrangement of generally prolate turbines according to an embodiment of the invention.

FIG. 5 illustrates an offset arrangement of generally prolate turbines according to an embodiment of the invention.

FIG. 6 illustrates an exploded view of a first arrangement of components of a generally prolate turbine according to an embodiment of the invention.

FIG. 7 illustrates a cut-away view of components of the turbine of FIG. 6 without casing.

FIG. 8 is an exploded view of a second arrangement of components of a generally prolate turbine.

### DETAILED DESCRIPTION OF THE INVENTION

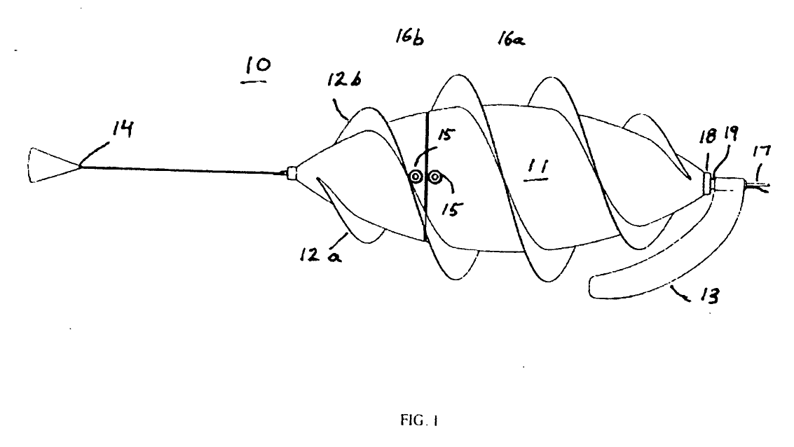

FIG. 1 illustrates a top plan view of an embodiment of a generally prolate turbine 10. The turbine 10 includes two generally helicoid working members 12a, 12b that spiral around a generally prolate casing 11. The two working members 12a, 12b are interleaved like double-start screw threads. A fin 13 is mounted at an upstream end of the casing, and an optional drag 14 is mounted at the opposite (downstream) end from the fin 13.

When the turbine 10 is placed on the surface of flowing water and secured at the upstream end by a tether (not shown), water naturally orients the turbine 10 with the upstream end (with fin 13) pointing upstream (to the right in FIG. 1), and the downstream end (with drag 14) pointing downstream. In such an orientation, the water flow impinging on the helicoid working members 12a, 12b causes the working members 12a, 12b and attached casing 11 to rotate.

The casing 11 is generally prolate, that is, generally symmetrical about a central axis, wider in the middle, and narrower at the ends. The casing 11 may be manufactured in two parts with an upstream shell 16a and downstream shell 16b. While a generally prolate casing is desired, the degree of curvature of casing 11 is not critical, and the casing need not be a mathematically perfect prolate shape. The embodiment of FIG. 1 shows two working members 12a, 12b, though a different number of working members may be used. The embodiment of FIG. 1 has working members with a lead (axial distance covered by one turn of the thread) of approximately one-half the length of the turbine, but other leads may be used.

The fin 13 preferably mounts at the upstream end of the casing to a hollow shaft 19 and projects away from the central axis into the fluid stream. The shaft 19 penetrates the casing 11 through a bearing and seal 18 and extends along at least part of the interior central axis of the casing 11. The fin 13 maintains a generally stable position at the water surface. The bearing 18 allows rotation of the casing 11 relative to the shaft 19 and fin 13, and the water seal prevents water penetration. The fin 13 holds the shaft 19 in a relatively fixed rotational position while the casing 11 rotates about the shaft 19. As will be discussed further below, the shaft 19 couples internally to a stator-like element of an electric generator (not shown), and the casing 11 couples internally to a rotor-like element. Torque from the working elements 12a, 12b may be coupled through the generator to the shaft 19 and cause the shaft 19 to roll. Such roll dips the fin 13 deeper into the water, which increases the fin's counter-balancing torque and keeps the stator-like element fixed relative to plane of the water surface. Electrical conductors 17 carrying electricity from the internal generator (not shown) preferably exit the casing 11 through the interior of the hollow shaft 19.

The turbine 10 of FIG. 1 preferably is positively buoyant and floats on the surface. Nevertheless, it may be advantageous to adjust the buoyancy, and the turbine 10 may include internal ballast bladders or compartments (not shown) with access ports 15 to allow positive or negative buoyancy.

An optional drag 14 attaches to the casing 11 at the downstream end. The illustrated drag has a semi-rigid shaft and terminates with conical, cross-fin, or other tail. The drag 14 assists in maintaining turbine orientation similar to the way the fins on an arrow maintain the head pointing in the direction of flight, that is, by providing fluid drag downstream of the center of mass.

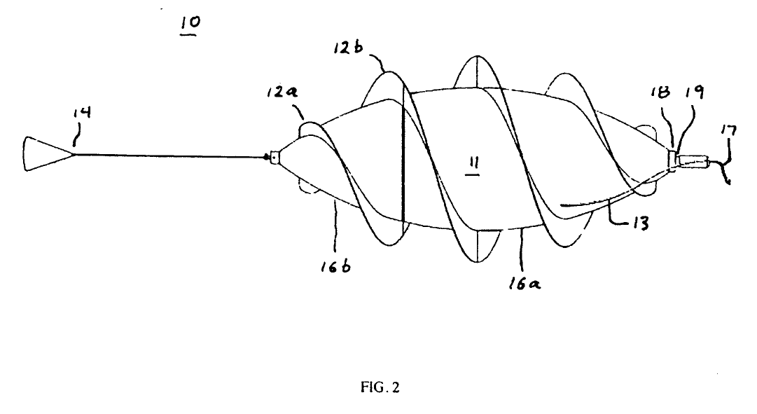

FIG. 2 illustrates a side plan view of a generally prolate turbine 10. This view illustrates the curvature of the fin 13. Under light load from the generator and working members 12a, 12b, the shaft 19 rotates so that the fin 13 is only slightly in the water. As generator load increases, the shaft 19 rolls further so that more of the fin dips into the water flow, which in turn increases the balancing force acting on the fin 13. The shaft 19 rolls until the fin 13 generates an amount of torque to balance to the torque imparted by the working members 12a and 12b through the casing 11 and internal generator (not shown).

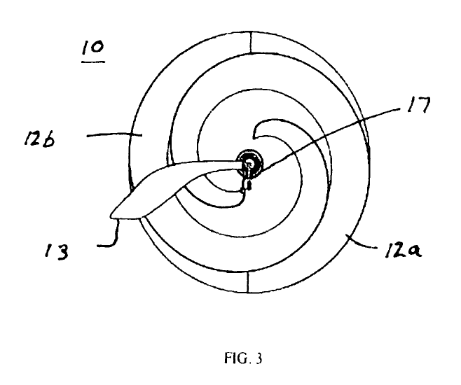

FIG. 3 illustrates a front plan view of a generally prolate turbine 10. This view better illustrates the interleaved-relationship of the two working members 12a, 12b. It also better illustrates how rotation of the fin 13 increases the exposure of the fin 13 to water and thus increases the amount of counter-balancing torque developed by the fin 13.

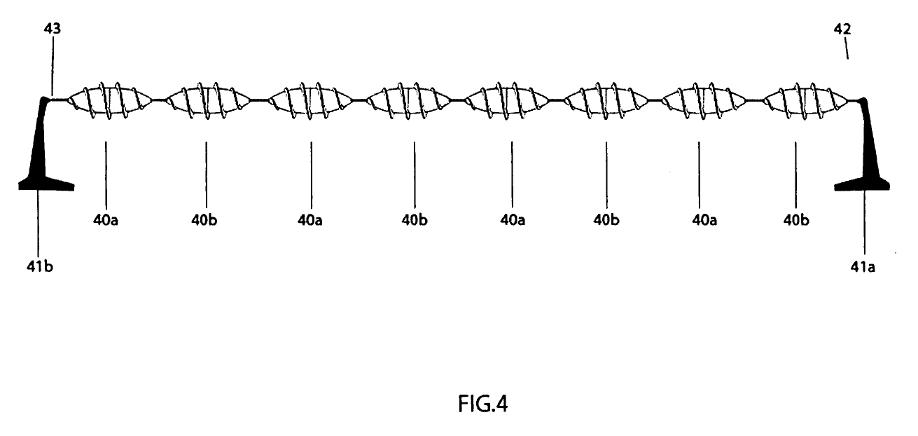

FIG. 4 illustrates a series arrangement of generally prolate turbines 40a, 40b held with their axes of rotation generally aligned with a prevailing current flow between two submerged anchorages 41a, 41b. The turbines 40a, 40b are essentially the same as the turbines of FIGS. 1-3 in that each turbine 40a, 40b has a generally helicoid working member rotating a generally prolate casing to cause relative opposite rotation between a stator-like element and a rotor-like element. The generally helicoid working members will generate power in reversing flows, such as tidal flows, without need for re-orientation.

When completely submerged in series, the turbines may omit stabilizing fins. Instead, alternating turbines counter-rotate, and upstream turbines provide counter-rotational torques to downstream turbines. For example, the casing of an upstream turbine couples through a universal joint to the shaft (and ultimately rotor-like element) of a downstream turbine. More than stabilizing the downstream stator-like element, the upstream turbine counter-rotates the stator-like elements of the downstream turbines. In FIG. 4, for example, turbines 40a may rotate in a clockwise direction about their axis of rotation, while turbines 40b rotate in the opposite direction. For a turbine in the middle of the series, its working member drives its own, internal, rotor-like element in one direction, while the working member of the immediate upstream turbine drives the stator-like member in an opposite direction. Generators transfer electricity through brushes to cables or other electrical conductors (not shown), which in turn pass between turbines and ultimately transfer electricity to fixed connections on one or both anchorages 41a, 41b.

At the upstream end of the series of turbines, an upstream anchorage 41a connects through a shaft 42 or other non-rotating attachment to the stator-like element of the first turbine. At the downstream end of the series of turbines, a downstream anchorage 41b attaches to the rotating casing of the last turbine through a shaft, cable or other attachment. The downstream attachment may be fixed to the casing through a bearing at either the downstream turbine or the anchorage 41b to allow rotation of the turbine relative to the anchorage 41b. In the arrangement of FIG. 4, torques on the stator-like elements of turbines ultimately are derived from the fluid flow, except for the first turbine of the series, which may derive torque from the upstream anchorage 41a.

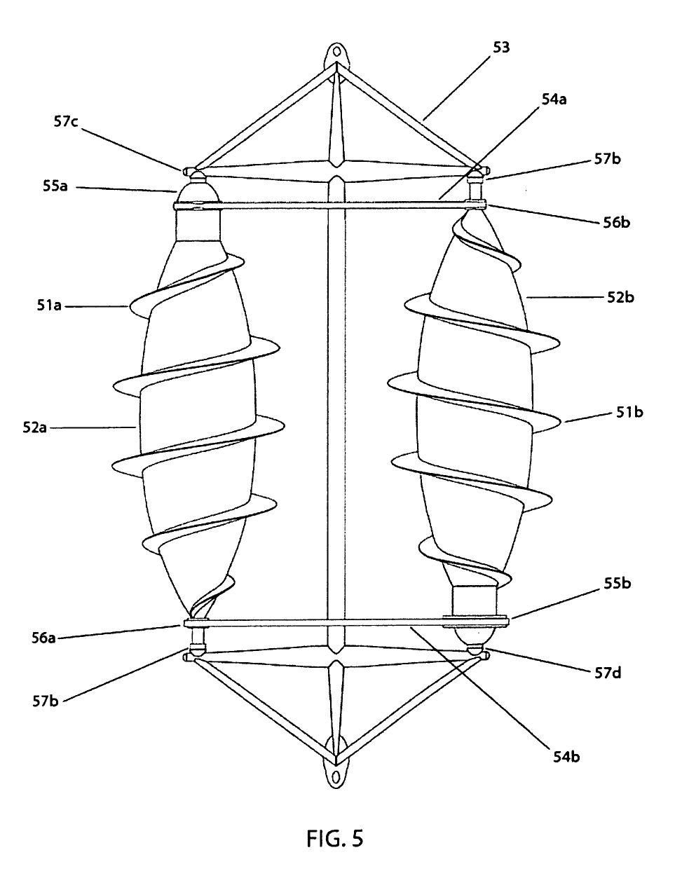

FIG. 5 illustrates a parallel arrangement of generally prolate turbines held in a frame 53 with their axes of rotation parallel, offset, and generally aligned with a prevailing current flow. The turbines are essentially the same as the turbines of FIG. 4 in that each turbine has a generally helicoid working member 51a, 51b rotating a generally prolate casing 52a, 52b to cause rotation of a rotor-like element relative to a stator-like element. Turbine casings 52a, 52b counter-rotate.

The casings 52a, 52b of turbines each connect internally to a rotor-like element. Each of the casings 52a, 52b also connects externally through drive system 54a, 54b to the stator-like element of the other turbine. The drive systems 54a, 45b preferably are belt or chain drives, but other mechanical couplings may be used. The casings 52a, 52b power the drive systems 54a, 54b through drive members 55a, 55b, which are pulleys in the case of a belt drive, or sprockets in the case of chain drives. The opposite end of the drive system 54a, 54b from the drive members that cause counter rotation 55a, 55b are corresponding pulleys or sprockets coupled to shafts that connect internally to stator-like members of the adjacent turbine. The drive members and their corresponding pulleys or sprockets may have differing diameters to effect a step-up or step-down ratio. Shafts and casings may be journaled with bearings 57a, 57b, 57c, 57d to allow rotation of shafts and casings relative to the frame 53. Through this arrangement, each working member 51a, 51b applies a torque to its own casing and to the stator-like member of the neighboring turbine.

The parallel arrangement of turbines may be connected through a frame 53 to an anchorage (not shown). The counter-rotation and cross-coupling of turbines allows a balancing of torques so that the frame 53 experiences little if any net torque as a result of the action of the fluid on the working members 51a, 51b. Downstream bearings 57b, 57d will transfer axial (thrust) loads to the frame 53 that results from the fluid acting on the working members 51a, 51b.

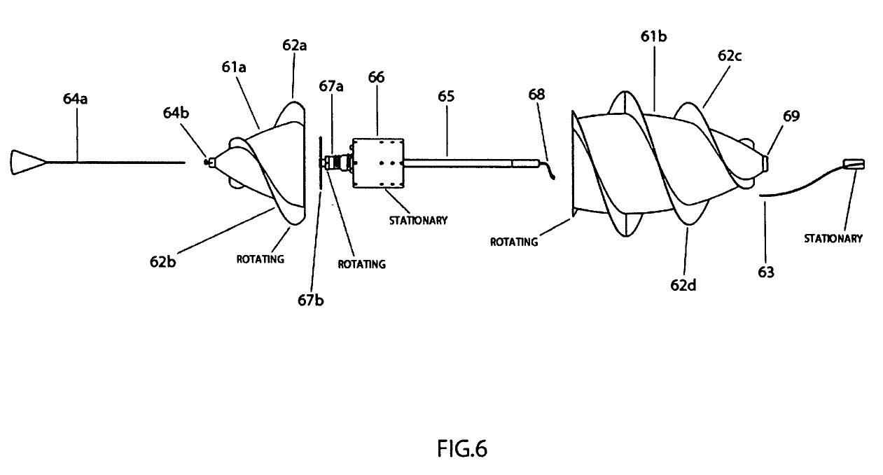

FIG. 6 illustrates an exploded view of a first arrangement of components of a generally prolate turbine. It shows a casing made of two parts 61a, 61b, with each part supporting portions of a generally helicoid working member 62a, 62b. When assembled, the casing parts 61a, 61b and working member portions 62a, 62b align to give an overall shape as the turbine of FIGS. 1-3. The turbine of FIG. 6 also has a fin 63 at the upstream end connected to a shaft 65, and a drag 64a at the downstream end connected at an attachment point 64b, similar to those of the turbine of FIGS. 1-3.

The fin 63 is designated as “stationary” with the understanding that it may experience some roll of a fraction of a revolution. In contrast, the casing is designated as “rotating” with the understanding that it will rotate through complete revolutions.

The fin 63 attaches to a shaft 65, which in turn connects to the stator or a stator-like member of an electric generator 66. The rotor or rotor-like member of the electric generator 66 attaches through a seal 67a and flange 67b to the downstream part of the casing 61a. Electric wires 68 carrying electricity from the stationary generator pass through the shaft 65. A bearing 69 mounted in the upstream part of the casing 61b allows relative rotation between the casing and the shaft 65. The shaft 65, generator 66, and wires 68 are designated as “stationary” similarly to the fin 63. Seals prevent water from causing electrical short circuits in the generator or any components carrying electricity.

The generator should be sized to the expected conditions of the prevailing fluid flow and to the geometry of the turbine so that the prevailing fluid flow turns the casing at a rotation rate that is optimal for the generator without need for a transmission to step-up or step-down the rate. An exemplary turbine might be eighty-eight (88) inches in length with a casing width of twenty-nine (29) inches at the widest point. The drag may extend fifty-two (52) inches. Two working members could be provided, each having a radial height of about 6.25 inches at the widest point and making two turns over the length of the casing. For river or tidal flows of about four (4) knots, a component generator could be a model 300STK4M manufactured by Alxion of Colombes, France. These dimensions are merely exemplary, and the turbines of substantially larger dimension are contemplated, including sizes appropriate for generating ones or tens of megawatts of power (comparable to thousands or tens of thousands of horsepower).

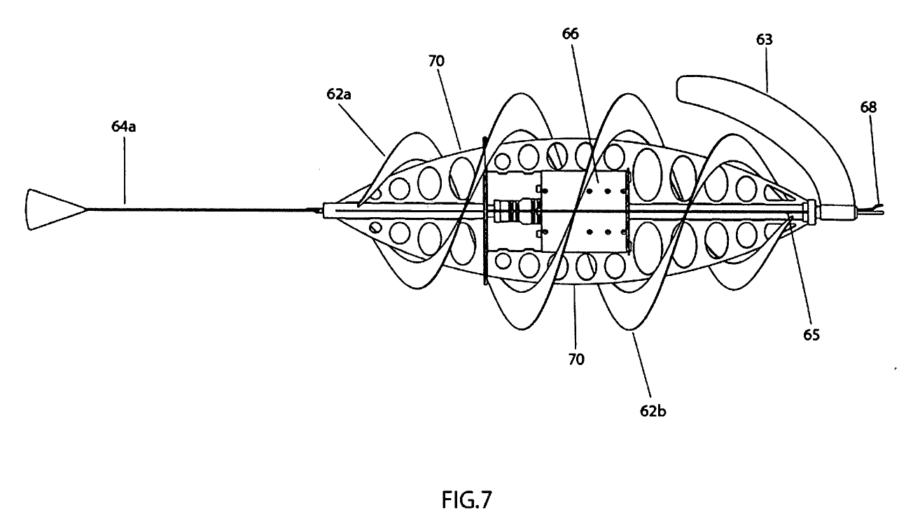

FIG. 7 illustrates a cut-away, assembled view of components of the turbine of FIG. 6 without casing. This figure illustrates working member sections 62a, 62b; fin 63; drag 64; shaft 65; generator 66; and electric wires 68 as described previously. Also shown are longitudinal, shape-support members 70 running axially along the length of the casing (not show). The shape-support members 70 may be made of continuous plate material but preferably have portions removed to reduce weight. Circumferential shape-support members may be used instead of axial members, especially in rotating sections that might contain ballast water.

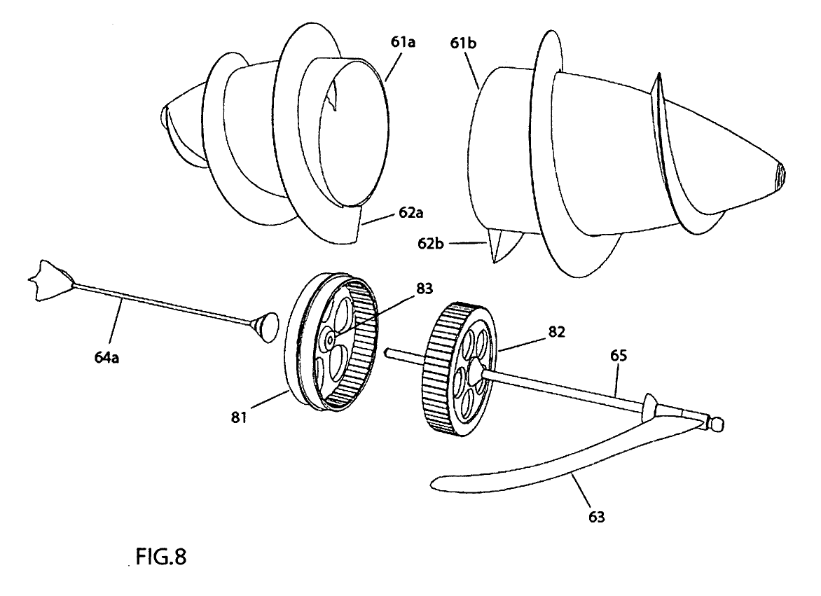

FIG. 8 is an exploded view of an alternate interior arrangement of rotor-like element 81 and stator-like element 82 for an electricity generator for a generally prolate turbine. This figure illustrates upstream and downstream casing sections 61a, 61b; working member sections 62a; 62b; fin 63; drag 64a; and shaft 65 as described previously. In this embodiment, the rotor-like element 81 has a diameter approximately equal to the casing and mounts directly to the interior of the downstream casing 62a. The rotor-like element 81 may be used to join the upstream and downstream casing sections together, such as by fastening both casing sections to the rotor-like element 81. The rotor-like element 81 includes a rotational thrust bearing 83 that transfers the axial load of the working members 62a, 62b to the shaft 65.

The embodiments described above are intended to be illustrative but not limiting. Various modifications may be made without departing from the scope of the invention. The breadth and scope of the invention should not be limited by the description above, but should be defined only in accordance with the following claims and their equivalents.

What is claim is:

1. An apparatus for generating electricity from a moving liquid comprising:
(a) a casing having an external shape that is generally symmetric about a first central axis, the casing having
(i) a first end,
(ii) a second end remote from the first end along the first central axis, and
(iii) a body portion between the first and second ends,
where the radial diameter of the casing in the body portion is predominantly larger than the radial diameter at the first and second ends;
(b) at least one generally helicoid working member coupled to the casing and adapted to cause rotation of the casing about the central axis in response to a liquid flow;
(c) first and second electricity-generation elements disposed inside the casing and adapted to generate electricity upon rotation of the first electricity-generation element relative to the second electricity-generation element, where the first electricity-generation element is coupled to receive a first torque generated by the working member; and
(d) a stabilizing portion configured to develop a torque on the second electricity-generation element in a direction opposing the first torque.

2. The apparatus of claim 1 wherein the stabilizing portion generates torque from the liquid flow.

3. The apparatus of claim 1 wherein the stabilizing portion includes a fin.

4. The apparatus of claim 1 wherein the stabilizing portion includes a shaft coupled to the second electricity-generation element, and the shaft penetrates the casing at an end of the casing.

5. The apparatus of claim 4 wherein the shaft couples to a fin.

6. The apparatus of claim 1 wherein the stabilizing portion includes a turbine with a working member.

7. The apparatus of claim 6 wherein the stabilizing portion includes
(a) a shaft, and
(b) a second turbine coupled to a shaft, and said second turbine has a second working member coupled to a second casing, said second casing having an external shape that is generally symmetric about a second central axis, where the second working member is adapted to cause rotation of the second casing about the second central axis in response to a liquid flow.

8. The apparatus of claim 7 wherein the second central axis is in serial axial alignment with the first central axis.

9. The apparatus of claim 7 wherein the second central axis is in offset parallel alignment with the first central axis of the apparatus.

10. The apparatus of claim 1 wherein axis of rotation of the first and second electricity-generating elements are substantially coaxial with the first central axis.

11. The apparatus of claim 1 wherein the at least one generally helicoid working member comprises a single screw thread.

12. The apparatus of claim 1 wherein the at least one generally helicoid working member comprises at least one screw thread extending axially along a majority of the length of the casing between the first and second ends.

13. The apparatus of claim 1 wherein the at least one generally helicoid working member comprises a double screw thread.

14. The apparatus of claim 1 further including a portion for adjusting buoyancy.

15. The apparatus of claim 1 further including a drag coupled to of (a) a stationary portion of the apparatus (b) a rotating portion of the apparatus.

16. An apparatus for generating electricity from a moving liquid comprising:
(a) a frame;
(b) a first turbine held by the frame, said first turbine having
(i) a first, generally prolate casing having a first central axis; and
(ii) a first, generally helicoid working member adapted to cause rotation of the first casing about the first central axis in a first direction in response to a liquid flow;
(c) a second turbine having
(i) a second, generally prolate casing having a second central axis; and
(ii) a second, generally helicoid working member adapted to cause rotation of the second casing about the second central axis in a second direction opposing the first direction in response to a liquid flow; and
(d) a mechanism coupling the first and second working members to electricity generating elements.

17. The apparatus of claim 16 wherein the first and second electricity generating elements are disposed within one of the first and second casings.

18. The apparatus of claim 16 wherein:
(a) the first working member couples to a first electricity generating element disposed within the first casing, and
(b) the drive mechanism couples the second working member to a second electricity generating element disposed within the first casing.

19. The apparatus of claim 18 wherein:
(a) the second working member couples to a third electricity generating element disposed within the second casing, and
(b) the drive mechanism couples the first working member to a fourth electricity generating element disposed with the second casing.

20. An apparatus for generating electricity from a moving liquid comprising:
(a) a casing having an external shape that is generally symmetric about a first central axis, the casing having
(i) a first end,
(ii) a second end remote from the first end along the first central axis, and
(iii) a body portion between the first and second ends,
where the radial diameter of the casing in the body portion is predominantly larger than the radial diameter at the first and second ends;
(b) at least one generally helicoid working member coupled to the casing and adapted to cause rotation of the casing about the central axis in response to a liquid flow;
(c) first and second electricity-generation elements disposed inside the casing and adapted to generate electricity upon rotation of the first electricity-generation element relative to the second electricity-generation element, where the first electricity-generation element is coupled to receive a first torque generated by the working member; and
(d) a stabilizing means for developing a torque on the second electricity-generation element in a direction opposing the first torque.

21. The apparatus of claim 20 wherein the stabilizing means generates torque from the liquid flow.

22. The apparatus of claim 20 wherein the stabilizing means includes a fin.

23. The apparatus of claim 20 wherein the stabilizing means includes a shaft coupled to the second electricity-generation element, and the shaft penetrates the casing at an end of the casing.

24. The apparatus of claim 20 wherein the stabilizing means includes a turbine with a working member.
